(19) United States
(12) Patent Application Publication
(10) Pub. No.: US 2019/0344458 A1
(43) Pub. Date: Nov. 14, 2019

(54) ASSISTED OPENING KNIFE WITH HANDLE PROVIDED WITH PUSHING KEY FOR RELEASING AND LOCKING BLADE

(71) Applicant: KANTAS PRODUCTS CO., LTD., Taipei City (TW)

(72) Inventor: Yang-Fu CHENG, Taipei City (TW)

(73) Assignee: KANTAS PRODUCTS CO., LTD., Taipei City (TW)

(21) Appl. No.: 16/019,604

(22) Filed: Jun. 27, 2018

(30) Foreign Application Priority Data
May 14, 2018 (TW) 107206281

(51) Int. Cl. B26B 1/04

(52) U.S. Cl. CPC B26B 1/044; B26B 1/048

(57) ABSTRACT

An assisted opening knife includes a handle with a pushing key for releasing and locking a blade. The blade is pivotally connected to the handle and has near its rear end a position-limiting post extending into an arcuate position-limiting groove in, and near the front end of, the handle. The assisted opening knife is characterized by the handle having therein a releasing/locking slide plate whose top side is provided with the pushing key and whose front end, a releasing/locking arm movable to a position near one end of the arcuate position-limiting groove. While the blade is stored in the handle, the position-limiting post touches the aforesaid end of the arcuate position-limiting groove and is locked by the releasing/locking arm to prevent the blade from rotation. The blade is rotatable again when the pushing key, exposed from the handle, is pushed and moves the releasing/locking arm away from the aforesaid position.

### FIELD OF THE INVENTION

The present invention relates to a folding knife and more particularly to an assisted opening knife whose handle is provided with a pushing key for releasing and locking the blade so as to render assistance to the opening, releasing, and locking of the blade, thereby making the assisted opening knife easier, more convenient, and safer to use, or more user-friendly in short.

### BACKGROUND OF THE INVENTION

Conventional assisted opening knives abound in the current market. Such a knife typically includes an elastic plate that helps push the blade. However, the inventor of the present invention has found that one who is using a conventional assisted opening knife tends to have problem applying an adequate pushing force to the pushing post of the knife due to the fact that the pushing post cannot be too long. The relatively short pushing post also requires that one who tries to push it with a thumb place the thumb close to the corresponding side of the blade, but the thumb will thus be within the range of movement of, and may therefore be cut by, the blade when the blade spins out of the handle rapidly. The fear f being cut while using the conventional assisted opening knife may reduce the user's willingness to keep using the knife.

In light of the above, and by improving the designs of the conventional assisted opening knives, the inventor of the present invention developed a novel assisted opening knife with a handle provided with a pushing key for releasing and locking a blade, for which the inventor was subsequently granted patent in many countries. The essential elements of this patented knife and their interactions are briefly described as follows. Referring to FIG. 1, the assisted opening knife B includes a first handle portion B1, a second handle portion B2, and a blade B3. The first handle portion B1 includes a first handle component B11, a pushing element B13, a pressing element B15, and a second handle component B17. A portion of the first handle component B11 that is adjacent to one end thereof is pivotally connected by a pivotal connection shaft B12 to a portion of the blade B3 that is adjacent to one end thereof. The blade B3, therefore, can be rotated about an axis defined by the pivotal connection shaft B12 either toward or away from the first handle component B11. In addition, the first handle component B11 is formed with an arcuate guide groove B111 adjacent to the aforesaid end of the first handle component B11 and has a lateral edge penetrated by a first aperture B113 and a second aperture B115.

With continued reference to FIG. 1, the blade B3 is protrudingly provided with a post B31 adjacent to the pivotal connection shaft B12. The post B31 extends through the arcuate guide groove B111 and can be displaced in the arcuate guide groove B111 in response to rotation of the blade B3. The pushing element B13 is positioned on one side of the first handle component B11 and has one end exposed from the first handle component B11 and forming a pushing portion B131 (as shown in FIG. 2A and FIG. 2B). A user can touch and push the pushing portion B131 with a finger or thumb in order to drive the pushing element B13. Moreover, the pushing element B13 is protrudingly provided with a sliding post B133 adjacent to the aforesaid end of the pushing element B13. The sliding post B133 extends through the first aperture B113 and can be displaced in the first aperture B113. The opposite end of the pushing element B13 corresponds in position to the second aperture B115.

Referring to FIG. 1 and FIG. 2A, the pressing element B15 is positioned on the other side (hereinafter referred to as the second side) of the first handle component B11 and is formed with a pushing plate B151 at one end, wherein the pushing plate B151 extends at an angle θ (e.g., 30-50 degrees) with respect to the main body of the pressing element B15. The pressing element B15 is further formed, or extended, with a locking plate B153 adjacent to the aforesaid end of the pressing element B15. With continued reference to FIG. 2A, when the blade B3 is stored between the first handle portion B1 and the second handle portion B2 and the post B31 has consequently been displaced to one end (hereinafter referred to as the blade storage end) of the arcuate guide groove B111, the user can push the pushing portion B131 with a finger or thumb so that the sliding post B133 abuts against a wall portion of the first aperture B113 that is adjacent to the aforesaid end of the blade B3. During the process, the pushing plate B151 will be displaced along the first handle component B11 toward the aforesaid end of the blade B3 without touching the post B31, and the locking plate B153 will be displaced to a position corresponding to the arcuate guide groove B111 in order for the locking plate B153 to lock the post B31 in the gap between the locking plate B153 and the aforesaid end of the arcuate guide groove B111. Consequently, the post B31 is kept from displacement toward the other end (hereinafter referred to as the blade-opening end) of the arcuate guide groove B111 and is in a locked state, in which the post B31 can no longer be moved together with the blade B3.

When the pushing portion B131 is subsequently pushed to displace the sliding post B133 along the first aperture B113 to a wall portion of the first aperture B113 that is away from the aforesaid end of the blade B3, referring to FIG. 2B, both the pushing plate B151 and the locking plate B153 are displaced along the first handle component B11 away from the aforesaid end of the blade B3. During the process, the locking plate B153 is moved away from the arcuate guide groove B111, and the pushing plate B151 first abuts against the post B31 and then pushes the post B31 toward the blade-opening end of the arcuate guide groove B111. Once the blade B3 is pushed to a certain position (i.e., when the blade B3 has been rotated by a certain angle), a spiral spring or other element will drive the blade B3 out to the greatest extent automatically.

Referring back to FIG. 1, the second handle component B17 is mounted on the second side of the first handle component B11 to cover the pressing element B15 and give the first handle portion B1 a neat and visually pleasing look. The pivotal connection shaft B12 is provided at one end of the second handle portion B2 to enable pivotal connection between the blade B3 and the first and the second handle portions B1 and B2. A user only has to operate the pushing portion B131, and the post B31 will be either locked to keep the blade B3 securely stored and positioned between the handle portions B1 and B2 (as shown in FIG. 2A), or unlocked to allow the blade B3 to be pushed, and thus rotated, by the pushing plate B151. As such, the assisted opening knife B features great convenience of use.

Indeed, the assisted opening knife B previously created by the inventor of present invention can be used more conveniently, more swiftly, and more safely than its prior art counterparts, but after actually manufacturing, using, and testing the assisted opening knife B, the inventor has found that, among other issues, the multiplicity of components, the complicated connections and driving relationships between the components, and the laborious and time-consuming assembly process of the assisted opening knife B have led to an elevated production cost, which translates into a high selling price and potentially low acceptance by consumers.

The issue to be addressed by the present invention, therefore, is to overcome the drawbacks of the foregoing assisted opening knife through effective simplification of its components and of the connections and driving relationships between the components so as to enable a significant reduction in production cost, an affordable selling price, great convenience and high safely of use, and total elimination of the risk of injury during operation.

### BRIEF SUMMARY OF THE INVENTION

In view of the fact that the conventional assisted opening knives have long failed to fully satisfy user needs, the inventor of the present invention incorporated years of practical experience in the design, development, and manufacture of knives and related products into extensive research, prototype production, and tests and finally succeeded in designing an assisted opening knife whose handle is provided with a pushing key for releasing and locking the blade. The invention is intended to solve the aforementioned problems of the conventional assisted opening knives at once, in particular the exceedingly high production cost, the lack of safety during use, and inconvenience of operation.

One objective of the present invention is to provide an assisted opening knife that includes a handle with a pushing key for releasing and locking a blade. The assisted opening knife includes a lower handle portion, an upper handle portion, a spacer, an upper decorative plate, a releasing/locking slide plate, a first auxiliary elastic element, and a main elastic element, in addition to the blade. The blade is formed with a blade tip at the front end and is protrudingly provided with a position-limiting post adjacent to the rear end. A portion of the upper handle portion that is adjacent to the front end of the upper handle portion and a portion of the lower handle portion that is adjacent to the front end of the lower handle portion are pivotally connected by a pivotal connection shaft to a portion of the blade that is adjacent to the rear end of the blade; as a result, the upper handle portion and the lower handle portion are coupled together to form a handle to be held in a user's hand, with a blade storage space formed between the upper handle portion and the lower handle portion so that the blade can be rotated either into or out of the blade storage space. The upper handle portion is formed with an arcuate position-limiting groove adjacent to the front end of the upper handle portion. The arcuate position-limiting groove has a circular arc shape centered at the pivotal connection shaft and is so configured and located that the free end of the position-limiting post extends through the arcuate position-limiting groove, and that the arcuate position-limiting groove limits the extent to which the position-limiting post, and hence the blade, can be rotated. The position-limiting post is displaced along the arcuate position-limiting groove in response to rotation of the blade, abuts against one end (i.e., the blade storage end) of the arcuate position-limiting groove when the blade is completely stored in the blade storage space, and abuts against the opposite end (i.e., the blade-opening end) of the arcuate position-limiting groove when the blade has been rotated out of the blade storage space to the greatest extent. The spacer is mounted between the inner side of the upper handle portion and the inner side of the lower handle portion at a position adjacent to a common lateral side of the two handle portions such that the blade storage space is formed between the handle portions and corresponds in position to the spacer when the handle portions are coupled together to form the handle. The upper decorative plate is fixed on the top side of the upper handle portion, has a top side formed with a key groove adjacent to the front end of the upper decorative plate, and has a bottom side concavely provided with a receiving space corresponding in position to the key groove, wherein the receiving space is in communication with the key groove and corresponds in configuration to the arcuate position-limiting groove such that, after extending through the arcuate position-limiting groove, the free end of the position-liming post extends to a corresponding position in the receiving space. The releasing/locking slide plate is mounted in the receiving space in a forwardly and rearwardly movable manner. The top side of the releasing/locking slide plate is protrudingly provided with a pushing key, which is exposed from the top side of the upper decorative plate through the key groove. A user, therefore, can push the pushing key forward or rearward with a finger or thumb so that the releasing/locking slide plate is displaced forward or rearward along with the pushing key. The front end of the releasing/locking slide plate is extended with a releasing/locking arm configured to be moved to a position corresponding to the arcuate position-limiting groove. When the position-limiting post abuts against the blade storage end (i.e., the blade storage end) of the arcuate position-limiting groove, the releasing/locking arm locks the position-limiting post and thereby brings the position-limiting post and hence the blade into a locked state, in which the position-limiting post cannot be rotated together with the blade. The first auxiliary elastic element is mounted between the releasing/locking slide plate and the upper handle portion and is configured to apply a first elastic force to the releasing/locking slide plate, wherein the first elastic force tends to displace the releasing/locking slide plate forward. When the blade is rotated to be completely stored in the blade storage space, the first auxiliary elastic element presses the releasing/locking slide plate and thereby displaces the releasing/locking arm, bringing the releasing/locking arm into the locked state, in which the position-limiting post is locked by the releasing/locking arm. Afterward, only when the user overcomes the first elastic force by pushing the pushing key rearward with a finger or thumb can the releasing/locking arm be displaced along with the pushing key to an unlocked state, in which the position-limiting post is released from the releasing/locking arm and therefore can be rotated together with the blade again. The main elastic element has a first end fixed in the handle at a position adjacent to the rear end of the handle and an opposite second end extending to a position in the handle that is adjacent to where the handle and the blade are pivotally connected. When the blade is completely stored in the handle, the second end of the main elastic element applies a storing torque to the blade, wherein the storing torque tends to rotate the blade inward of the handle. When the user has rotated the blade out of the handle by a predetermined angle, the main elastic element applies an outward spinning torque to the blade. The outward spinning torque rotates the blade further outward of the handle until the blade has been rotated out of the handle to the greatest extent. Thus, with the releasing/locking slide plate capable of keeping the blade in the storage state when the blade is completely stored in the blade storage space and in the fully opened state when the blade has been rotated out of handle to the greatest extent, the safety and stability with which the assisted opening knife can be stored or used are effectively enhanced.

### BRIEF DESCRIPTION OF THE SEVERAL VIEWS OF THE DRAWINGS

The objectives and technical features of the present invention and the effects of the technical features can be better understood by referring to the following detailed description in conjunction with the accompanying drawings, in which:

FIG. 1 is an exploded perspective view of a conventional assisted opening knife;

FIG. 2A schematically shows a state in which the blade of the conventional assisted opening knife in FIG. 1 is completely stored in the handle;

FIG. 2B schematically shows another state in which the blade of the conventional assisted opening knife in FIG. 1 is completely stored in the handle;

FIG. 3 is an exploded perspective view of an assisted opening knife according to the present invention;

FIG. 4 is an assembled perspective view of the assisted opening knife in FIG. 3;

FIG. 5 is an exploded bottom view of the upper decorative plate and related components of the assisted opening knife in FIG. 3;

FIG. 6 is an assembled bottom view of the upper decorative plate and related components in FIG. 5;

FIG. 7 schematically shows a state in which the blade of the assisted opening knife in FIG. 3 has been rotated out of the handle to the greatest extent;

FIG. 8 schematically shows a state in which the blade of the assisted opening knife in FIG. 3 is completely stored in the handle; and

FIG. 9(a)˜FIG. 9(d) schematically show the interactions between the releasing/locking slide plate, the auxiliary slide plate, and the blade of the assisted opening knife in FIG. 3 while the blade is moved from a state of being completely stored in the handle to a state of having been rotated out of the handle to the greatest extent.

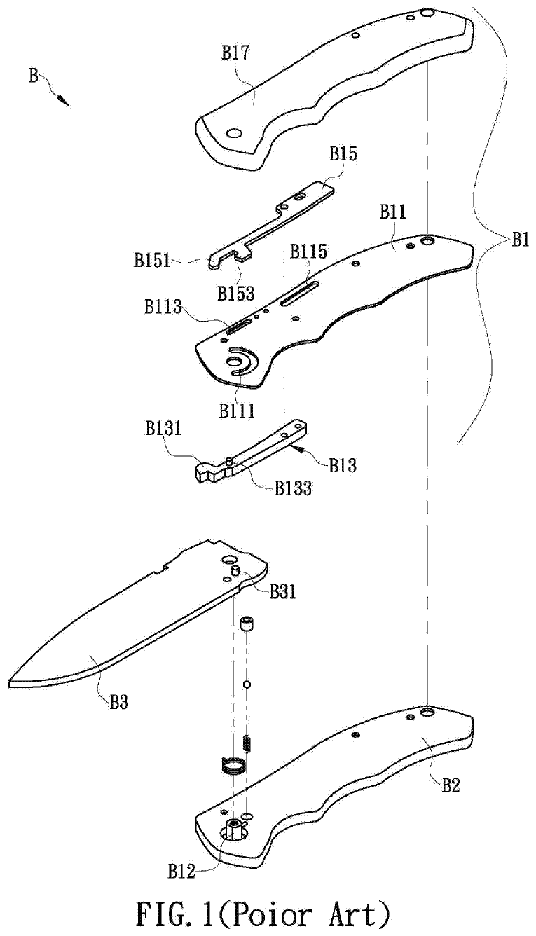

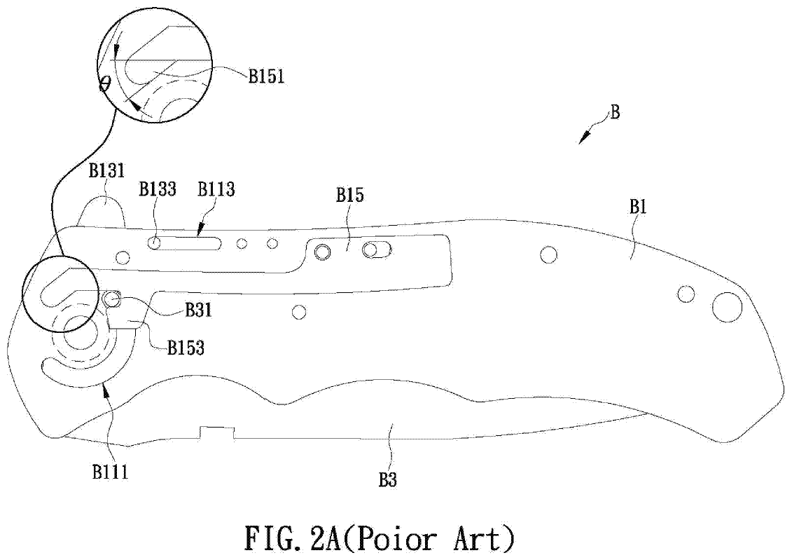

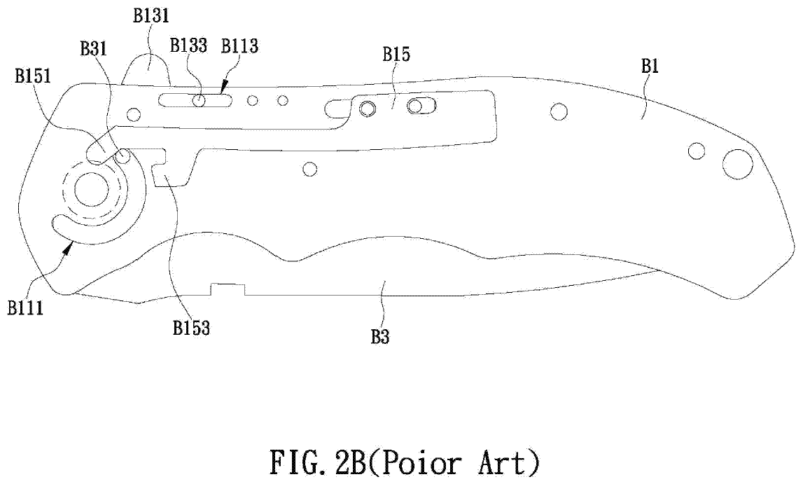

### DETAILED DESCRIPTION OF THE INVENTION

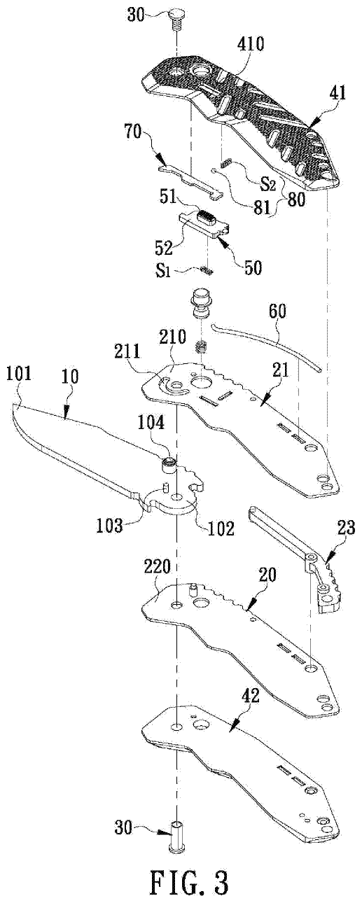

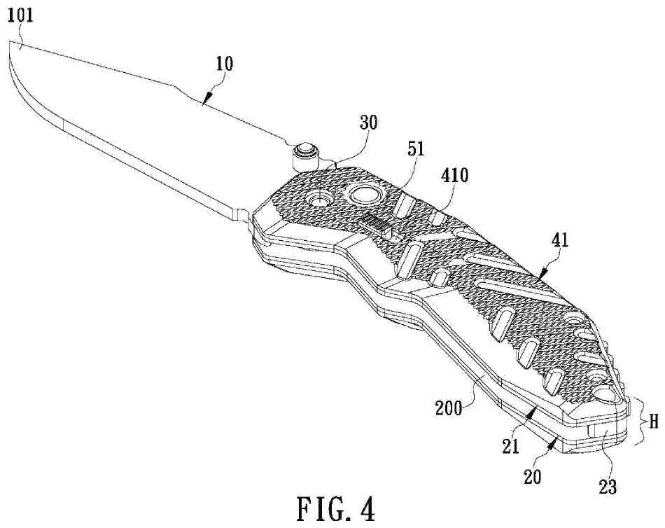

The present invention provides an assisted opening knife whose handle is equipped with a pushing key for releasing and locking the blade. Referring to FIG. 3, the assisted opening knife includes a blade 10, a lower handle portion 20, an upper handle portion 21, a spacer 23, an upper decorative plate 41, a releasing/locking slide plate 50, a first auxiliary elastic element S₁, and a main elastic element 60. The blade 10 is formed with a blade tip 101 at the front end and is protrudingly provided with a position-limiting post 103 in a portion 102 adjacent to the rear end. The lower handle portion 20 lies below the blade 10 while the upper handle portion 21 is above the blade 10. A portion 210 of the upper handle portion 21 that is adjacent to the front end of the upper handle portion 21 and a portion 220 of the lower handle portion 20 that is adjacent to the front end of the lower handle portion 20 are each pivotally connected by a pivotal connection shaft 30 to the portion 102 of the blade 10 that is adjacent to the rear end of the blade 10. Thus, referring to FIG. 4, the upper handle portion 21 and the lower handle portion 20 are coupled together to form a handle H to be held in a user's hand, and a blade storage space 200 is formed between the upper handle portion 21 and the lower handle portion 20. The blade 10 can be rotated with respect to the upper handle portion 21 and the lower handle portion 20 about an axis defined by the pivotal connection shafts 30 so as to be stored in or stay outside the blade storage space 200.

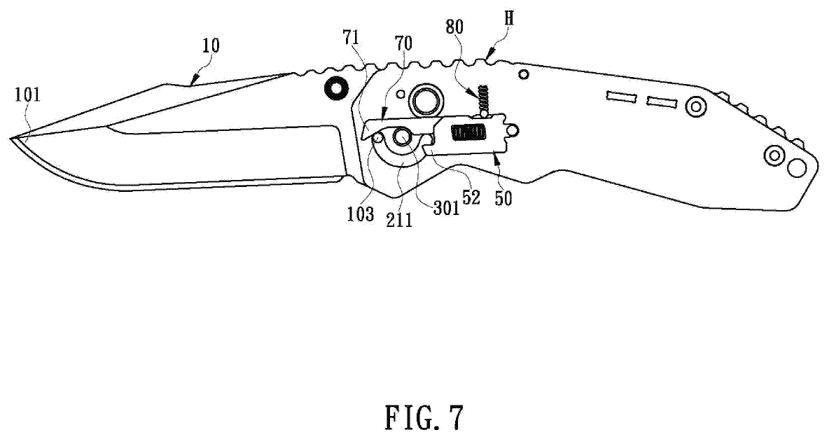

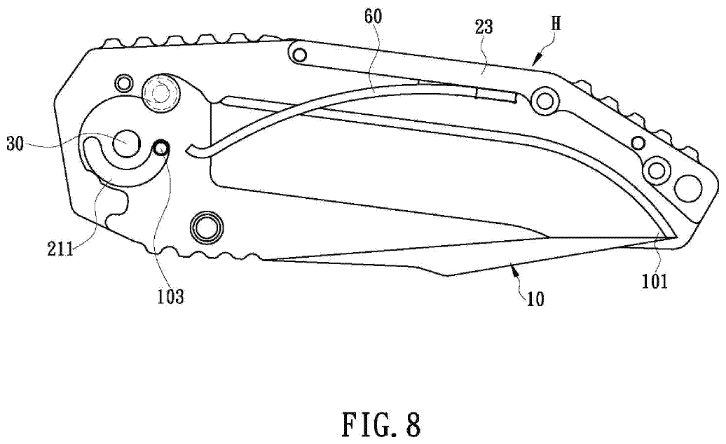

In this embodiment of the present invention, referring back to FIG. 3, the portion 210 of the upper handle portion 21 that is adjacent to the front end of the upper handle portion 21 is formed with an arcuate position-limiting groove 211. The arcuate position-limiting groove 211 has the pivotal connection shafts 30 as the center of its circular arc shape and is configured and located to allow the free end of the position-limiting post 103 to extend through the arcuate position-limiting groove 211 such that the arcuate position-limiting groove 211 limits the extent to which the position-limiting post 103, and consequently the blade 10, can be rotated. The position-limiting post 103 is displaced in the arcuate position-limiting groove 211 when the blade 10 is rotated. The position-limiting post 103 abuts against one end (i.e., the blade storage end) of the arcuate position-limiting groove 211 when the blade 10 is completely stored in the handle H, as shown in FIG. 8, and the other end (i.e., the blade-opening end) of the arcuate position-limiting groove 211 when the blade 10 has been rotated out of the handle H to the greatest extent, as shown in FIG. 7. Referring again to FIG. 3, the spacer 23 is mounted between the inner sides of the upper handle portion 21 and of the lower handle portion 20 at a position adjacent to a common lateral side of the two handle portions; therefore, once the upper handle portion 21 and the lower handle portion 20 are coupled together to form the handle as shown in FIG. 4, the blade storage space 200 is formed between the upper handle portion 21 and the lower handle portion 20 at a position corresponding to the spacer 23.

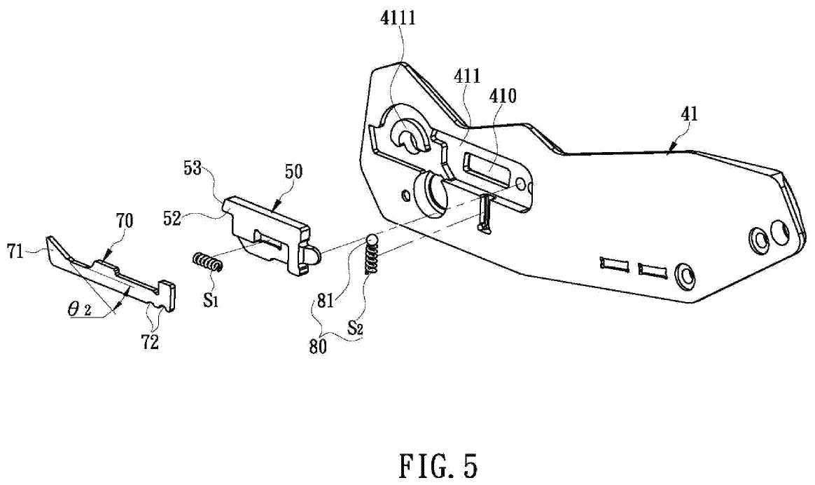

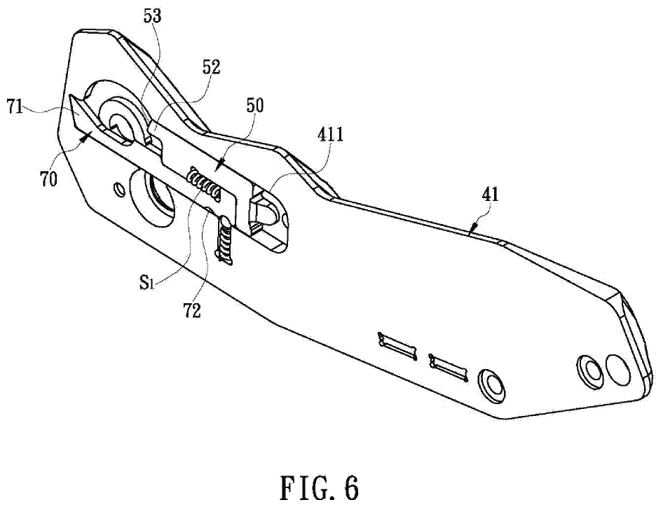

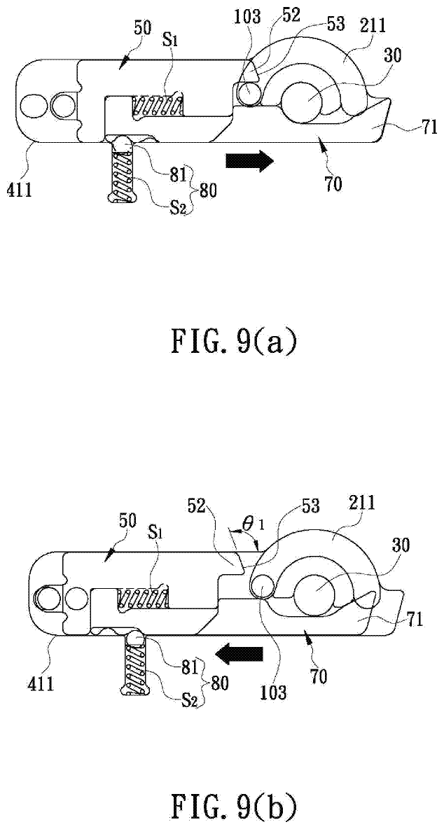

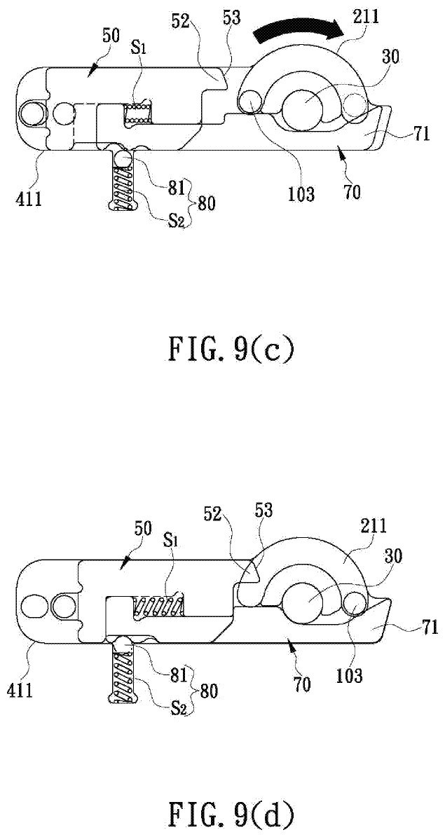

In this embodiment of the present invention, referring again to FIG. 3 and FIG. 4, the upper decorative plate 41 is fixed on the top side of the upper handle portion 21 and has a top side formed with a key groove 410 adjacent to the front end of the upper decorative plate 41. The bottom side of the upper decorative plate 41 is concavely provided with a receiving space 411 corresponding in position to the key groove 410, as shown in FIG. 5. The receiving space 411 is in communication with the key groove 410 and corresponds in configuration to the arcuate position-limiting groove 211 such that, after penetrating the arcuate position-limiting groove 211, the free end of the position-limiting post 103 reaches a corresponding position 4111 in the receiving space 411. Referring to FIG. 6, the releasing/locking slide plate 50 is mounted in the receiving space 411 in a forwardly and rearwardly movable manner. Referring back to FIG. 3 and FIG. 4, the top side of the releasing/locking slide plate 50 is protrudingly provided with a pushing key 51, which is exposed from the top side of the upper decorative plate 41 through the key groove 410 so as to be pushed by a user's finger or thumb. When the pushing key 51 is pushed forward or rearward, the releasing/locking slide plate 50 is displaced forward or rearward along with the pushing key 51. The front end of the releasing/locking slide plate 50 is extended with a releasing/locking arm 52. The releasing/locking arm 52 is so configured that it can be moved to a position corresponding to the arcuate position-limiting groove 211. When the position-limiting post 103 abuts against the blade storage end of the arcuate position-limiting groove 211 (i.e., when the blade 10 is completely stored in the handle H) as shown in FIG. 9(a), the releasing/locking arm 52 locks the position-limiting post 103 and thereby bring the position-limiting post 103 and consequently the blade 10 into a locked state, in which the position-limiting post 103 cannot be rotated together with the blade 10. As shown in FIG. 3 and FIG. 9(a), the first auxiliary elastic element S₁ is mounted between the releasing/locking slide plate 50 and the upper handle portion 21 (or the upper decorative plate 41) and is configured to apply a first elastic force to the releasing/locking slide plate 50, wherein the first elastic force tends to displace the releasing/locking slide plate 50 forward, as indicated by the bold arrow in FIG. 9(a). While the blade 10 is rotated to be completely stored in the handle H, the releasing/locking slide plate 50 is pressed by the first auxiliary elastic element S₁ such that the releasing/locking arm 52 is displaced and eventually enters the locked state, in which the position-limiting post 103 is locked by the releasing/locking arm 52 and therefore cannot be rotated together with the blade 10. After that, only when the first elastic force is overcome by the user pushing the pushing key 51 rearward with a finger or thumb (as indicated by the bold arrow in FIG. 9(b)) can the releasing/locking arm 52 be displaced along with the pushing key 51 to an unlocked state, in which the position-limiting post 103 is released from the releasing/locking arm 52 and can therefore be rotated together with the blade 10 again.

In this embodiment of the present invention, referring to FIG. 3 and FIG. 8, the main elastic element 60 is an elastic plate (or rod). One end of the main elastic element 60 is fixed in the handle H at a position adjacent to the rear end of the handle H. The opposite end (hereinafter referred to as the second end) of the main elastic element 60 extends to a position in the handle H that is adjacent to the pivotal joint between the handle H and the blade 10. While the blade 10 is completely stored in the handle H, the second end of the main elastic element 60 generates a torque (referred to herein as a storing torque) that acts on the blade 10 and tends to rotate the blade 10 inward of the handle H. When the blade 10 has been rotated out of the handle H by a predetermined angle (about 4-8 degrees), the second end of the main elastic element 60 generates another torque (referred to herein as an outward spinning torque) that acts on the blade 10 and rotates the blade 10 further outward of the handle H until the blade 10 has been rotated out of the handle H to the greatest extent.

In this embodiment, a conventional elastic plate (or rod) is used as the main elastic element 60 to help push the blade 10. In other embodiments of the present invention, a spiral spring can be used in place of the elastic plate (or rod) and be mounted at the pivotal joint between the blade 10 and the handle H to serve as the main elastic element 60 and help push the blade 10 by applying thereto a constant outward spinning torque that tends to rotate the blade 10 outward of the handle H. In that case, an engaging element in the handle H will apply an engaging force to the blade 10 when the blade 10 is completely stored in the handle H, in order for the engaging force to keep the blade 10 securely stored and positioned in the handle H. It can be known from the above that the structural details of and connections between the blade 10, the main elastic element 60, and the handle H of the disclosed assisted opening knife may vary, provided that the main elastic element 60 can apply an outward spinning torque to the blade 10 when the blade 10 has been rotated by a predetermined angle (about 4-8 degrees) from the position of being stored completely in the handle H, and that the outward spinning torque can cause further rotation of the blade 10 outward of the handle H until the blade 10 has been rotated out of the handle H to the greatest extent.

When it is desired to rotate the blade 10 from inside the handle H to the outside, referring to FIG. 3, FIG. 4, and FIG. 9(b), the user only has to overcome the first elastic force by pushing the pushing key 51 rearward with a finger or thumb as indicated by the bold arrow in FIG. 9(b), and the releasing/locking arm 52 will be displaced along with the pushing key 51 to the unlocked state, in which the position-limiting post 103 is released from the releasing/locking arm 52 so that the blade 10 can be rotated out of the handle H in order to be used. To make it easier for the user to rotate the blade 10, referring to FIG. 3, the blade 10 may be provided with a pushing post 104, which remains exposed from the handle H while the blade 10 is stored in the handle H.

In this embodiment, referring again to FIG. 3 and FIG. 9(b), the front end edge of the releasing/locking arm 52 is formed with a pressing wall 53, and there is a pressing angle θ₁ between the wall surface of the pressing wall 53 and the moving direction of the releasing/locking slide plate 50 (or the extending direction of the releasing/locking arm 52). When the position-limiting post 103 is displaced but has yet to abut against the blade storage end of the arcuate position-limiting groove 211 (i.e., when the blade 10 is rotated but has yet to be stored completely in the handle H), the position-limiting post 103 presses the pressing wall 53 and thereby moves the releasing/locking slide plate 50 rearward; as a result, the releasing/locking arm 52 is displaced and enters the unlocked state to clear the route provided by the arcuate position-limiting groove 211, allowing the position-limiting post 103 to be further displaced and eventually abut against the blade storage end of the arcuate position-limiting groove 211 (i.e., allowing the blade 10 to be further rotated and end up stored in the handle H completely). After that, referring to FIG. 9(a), the releasing/locking slide plate 50 is displaced forward by the first elastic force as indicated by the bold arrow in FIG. 9(a), thus bringing the releasing/locking arm 52 back to the locked state, in which the position-limiting post 103 is locked by the releasing/locking arm 52 and hence cannot be rotated together with the blade 10, and in which therefore the user can store the assisted opening knife safely.

In this embodiment of the present invention, referring back to FIG. 3, the assisted opening knife further includes an auxiliary slide plate 70. As shown in FIG. 5 and FIG. 6, the auxiliary slide plate 70 is mounted in the receiving space 411 in a forwardly and rearwardly movable manner and has a lateral edge connected to the corresponding lateral edge of the releasing/locking slide plate 50 in order to be driven by the releasing/locking slide plate 50. With continued reference to FIG. 5 and FIG. 6, the front end of the auxiliary slide plate 70 is formed with an auxiliary pushing arm 71 that extends forward, and a pushing angle θ₂ is formed between the auxiliary pushing arm 71 and the moving direction of the releasing/locking slide plate 50. Referring to FIG. 9(c), the position-limiting post 103 abuts against the auxiliary pushing arm 71 when moved to a position adjacent to the blade-opening end of the arcuate position-limiting groove 211. The user can then apply a force to the position-limiting post 103 so that the free end of the position-limiting post 103 presses and thereby displaces the auxiliary pushing arm 71. The auxiliary slide plate 70 will be moved along with the auxiliary pushing arm 71 until the position-limiting post 103 reaches the blade-opening end of the arcuate position-limiting groove 211.

In this embodiment of the present invention, referring again to FIG. 3, the assisted opening knife further includes a locking element 80. As shown in FIG. 5 and FIG. 6, the locking element 80 includes an engaging head 81 and a second auxiliary elastic element S₂ and is mounted between the auxiliary slide plate 70 and the upper handle portion 21. The second auxiliary elastic element S₂ is configured to apply a second elastic force to the engaging head 81, wherein the second elastic force tends to displace the engaging head 81 and thus presses the engaging head 81 against a lateral edge of the auxiliary slide plate 70 to prevent the auxiliary slide plate 70 from both forward displacement and rearward displacement. When the blade 10 has been rotated out of the blade storage space 200 to the greatest extent, therefore, referring to FIG. 9(d), the engaging head 81 is pressed by the second auxiliary elastic element S₂ and keeps the auxiliary slide plate 70 in a locked state, meaning the auxiliary slide plate 70 cannot be displaced. When the user rotates the blade 10 back into the handle H, the position-limiting post 103 will abut against the pressing wall 53 while moving toward the blade storage end of the arcuate position-limiting groove 211. The user can then apply a force to the position-limiting post 103 to overcome the second elastic force, thereby displacing the releasing/locking slide plate 50 until the position-limiting post 103 reaches the blade storage end of the arcuate position-limiting groove 211, i.e., until the blade 10 is completely stored in the handle H.

In this embodiment of the present invention, referring back to FIG. 3, FIG. 5, and FIG. 6, the engaging head 81 is a steel ball, and the lateral edge of the auxiliary slide plate 70 that corresponds to the locking element 80 is concavely provided with at least one locking notch 72. When the blade 10 has been rotated out of the blade storage space 200 to the greatest extent as shown in to FIG. 9(d), the engaging head 81 is engaged in the corresponding locking notch 72 such that the auxiliary slide plate 70 enters the locked state and cannot be displaced forward or rearward.

In this embodiment of the present invention, with continued reference to FIG. 3, the assisted opening knife further includes a lower decorative plate 42 fixed on the bottom side of the lower handle portion 22. Besides, it is worth mentioning that the blade 10 can be fixed in position by a certain structure once rotated out of the blade storage space 200 to the greatest extent. Such structures are well known in the art and hence will not be described in more detail herein; however, a person skilled in the art who fully understands the technical features of the present invention should have no problem adapting such conventional structures to the present invention.

The embodiments described above are only some preferred ones of the present invention but not intended to be restrictive of the scope of the appended claims. All equivalent changes based on the disclosed technical contents and easily conceivable by a person skilled in the art should fall within the scope of the present invention.

What is claimed is:

1. An assisted opening knife with a handle provided with a pushing key for releasing and locking a blade, comprising:
the blade, which has a front end formed with a blade tip and is protrudingly provided with a position-limiting post adjacent to a rear end of the blade;
a lower handle portion below the blade;
an upper handle portion above the blade, wherein a portion of the upper handle portion that is adjacent to a front end of the upper handle portion and a portion of the lower handle portion that is adjacent to a front end of the lower handle portion are pivotally connected by a pivotal connection shaft to a portion of the blade that is adjacent to the rear end of the blade such that the upper handle portion and the lower handle portion are coupled together to form the handle, to be held in a user's hand, the upper handle portion and the lower handle portion also form a blade storage space therebetween, the blade is rotatable with respect to the upper handle portion and the lower handle portion about an axis defined by the pivotal connection shaft either into or out of the blade storage space, the upper handle portion is formed with an arcuate position-limiting groove adjacent to the front end of the upper handle portion, and the arcuate position-limiting groove has a circular arc shape centered at the pivotal connection shaft and is so configured and located that a free end of the position-limiting post extends through the arcuate position-limiting groove, that the arcuate position-limiting groove sets limits to rotation of the position-limiting post and hence of the blade, and that the position-limiting post is displaced along the arcuate position-limiting groove in response to rotation of the blade, abuts against a first end of the arcuate position-limiting groove when the blade is completely stored in the blade storage space, and abuts against an opposite second end of the arcuate position-limiting groove when the blade has been rotated out of the blade storage space to a greatest extent;
a spacer mounted between an inner side of the upper handle portion and an inner side of the lower handle portion at a position adjacent to a common lateral side of the upper handle portion and the lower handle portion such that the blade storage space is formed between the upper handle portion and the lower handle portion and corresponds in position to the spacer when the upper handle portion and the lower handle portion are coupled together to form the handle;
an upper decorative plate fixed on a top side of the upper handle portion, wherein the upper decorative plate has a top side formed with a key groove adjacent to a front end of the upper decorative plate and has a bottom side concavely provided with a receiving space corresponding in position to the key groove, and the receiving space is in communication the key groove and corresponds in configuration to the arcuate position-limiting groove such that, after extending through the arcuate position-limiting groove, the free end of the position-liming post reaches a corresponding position in the receiving space;
a releasing/locking slide plate mounted in the receiving space in a forwardly and rearwardly movable manner, wherein the releasing/locking slide plate has a top side protrudingly provided with the pushing key such that the pushing key is exposed from the top side of the upper decorative plate through the key groove in order to be pushed forward or rearward by the user with a finger or thumb, causing forward or rearward displacement of the releasing/locking slide plate along with the pushing key, and the releasing/locking slide plate has a front end extended with a releasing/locking arm configured to be moved to a position corresponding to the arcuate position-limiting groove such that, when the position-limiting post abuts against the first end of the arcuate position-limiting groove, the releasing/locking arm locks the position-limiting post and thereby brings the position-limiting post and hence the blade into a locked state, in which the position-limiting post together with the blade is not rotatable;
a first auxiliary elastic element mounted between the releasing/locking slide plate and the upper handle portion and configured to apply to the releasing/locking slide plate a first elastic force tending to displace the releasing/locking slide plate forward such that, when the blade is rotated to be completely stored in the blade storage space, the first auxiliary elastic element presses the releasing/locking slide plate and thereby displaces the releasing/locking arm, bringing the releasing/locking arm into the locked state, in which the position-limiting post is locked by the releasing/locking arm; and only when the user overcomes the first elastic force by pushing the pushing key rearward with a finger or thumb will the releasing/locking arm be displaceable along with the pushing key to enter an unlocked state, in which the position-limiting post is released from the releasing/locking arm and therefore rotatable together with the blade again; and
a main elastic element having a first end fixed in the handle at a position adjacent to a rear end of the handle and an opposite second end extending to a position in the handle that is adjacent to where the handle and the blade are pivotally connected, wherein when the blade is completely stored in the handle, the second end of the main elastic element applies to the blade a storing torque tending to rotate the blade inward of the handle: and when the blade has been rotated out of the handle by a predetermined angle by an external force, the main elastic element applies to the blade an outward spinning torque that rotates the blade further outward of the handle until the blade has been rotated out of the handle to the greatest extent.

2. The assisted opening knife of claim 1, further comprising an auxiliary slide plate mounted in the receiving space in a forwardly and rearwardly movable manner, wherein the auxiliary slide plate has a first lateral edge connected to a corresponding lateral edge of the releasing/locking slide plate in order to be driven by the releasing/locking slide plate; the auxiliary slide plate has a front end extended with an auxiliary pushing arm such that a pushing angle is formed between the auxiliary pushing arm and the releasing/locking slide plate or a moving direction of the auxiliary slide plate; and while the blade is being rotated out of the blade storage space to the greatest extent, the free end of the position-limiting post abuts against and then presses the auxiliary pushing arm until the position-limiting post abuts against the second end of the arcuate position-limiting groove.

3. The assisted opening knife of claim 1, wherein the releasing/locking arm has a front end edge formed with a pressing wall; the pressing wall has a wall surface forming a pressing angle with a moving direction of the releasing/locking slide plate or an extending direction of the releasing/locking arm; when displaced to abut against the first end of the arcuate position-limiting groove, the position-limiting post presses the pressing wall and thereby moves the releasing/locking slide plate rearward such that the releasing/locking arm is displaced and brought into the unlocked state, in which the releasing/locking arm releases a route provided by the arcuate position-limiting groove and thus allows the position-limiting post to be displaced and abut against the first end of the arcuate position-limiting groove; and once the position-limiting post abuts against the first end of the arcuate position-limiting groove, the releasing/locking slide plate is displaced forward by the first elastic force until the releasing/locking arm re-enters the locked state, in which the position-limiting post is locked by the releasing/locking arm and therefore not rotatable together with the blade.

4. The assisted opening knife of claim 2, wherein the releasing/locking arm has a front end edge formed with a pressing wall; the pressing wall has a wall surface forming a pressing angle with a moving direction of the releasing/locking slide plate or an extending direction of the releasing/locking arm; when displaced to abut against the first end of the arcuate position-limiting groove, the position-limiting post presses the pressing wall and thereby moves the releasing/locking slide plate rearward such that the releasing/locking arm is displaced and brought into the unlocked state, in which the releasing/locking arm releases a route provided by the arcuate position-limiting groove and thus allows the position-limiting post to be displaced and abut against the first end of the arcuate position-limiting groove; and once the position-limiting post abuts against the first end of the arcuate position-limiting groove, the releasing/locking slide plate is displaced forward by the first elastic force until the releasing/locking arm re-enters the locked state, in which the position-limiting post is locked by the releasing/locking arm and therefore not rotatable together with the blade.

5. The assisted opening knife of claim 2, further comprising a locking element, wherein the locking element comprises an engaging head and a second auxiliary elastic element; the locking element is mounted between the auxiliary slide plate and the upper handle portion; the second auxiliary elastic element is configured to apply to the engaging head a second elastic force tending to displace the engaging head such that the engaging head is pressed against a second lateral edge of the auxiliary slide plate and thus brings the auxiliary slide plate into a locked state, in which the auxiliary slide plate is unable to be displaced forward or rearward; when the blade has been rotated out of the blade storage space to the greatest extent, the engaging head is pressed by the second auxiliary elastic element and thus locks the auxiliary slide plate in the locked state, in which the auxiliary slide plate is unable to push the free end of the position-limiting post; and only when the user overcomes the second elastic force by pushing the pushing key rearward with a finger or thumb will the auxiliary slide plate be displaceable along with the pushing key.

6. The assisted opening knife of claim 4, wherein the engaging head is a steel ball; the second lateral edge of the auxiliary slide plate is concavely provided with at least one locking notch corresponding in position to the locking element; and when the blade is completely stored in the blade storage space or has been rotated out of the blade storage space to the greatest extent, the engaging head is engaged in the locking notch and thereby brings the auxiliary slide plate into the locked state, in which the auxiliary slide plate is unable to be displaced forward or rearward.

7. The assisted opening knife of claim 3, further comprising a lower decorative plate fixed on a bottom side of the lower handle portion.

8. The assisted opening knife of claim 4, further comprising a lower decorative plate fixed on a bottom side of the lower handle portion.

9. The assisted opening knife of claim 5, further comprising a lower decorative plate fixed on a bottom side of the lower handle portion.
